(19) United States
(12) Patent Application Publication
(10) Pub. No.: US 2026/0093354 A1
(43) Pub. Date: Apr. 2, 2026

(54) TOUCH CONTROLLER AND TOUCH IDENTIFICATION METHOD

(71) Applicant: Novatek Microelectronics Corp., Hsinchu (TW)

(72) Inventors: Kai-Chun Huang, Tainan City (TW); Chun Yuan Liu, Tainan City (TW); Che-Chia Hsu, Hsinchu City (TW)

(73) Assignee: Novatek Microelectronics Corp., Hsinchu (TW)

(21) Appl. No.: 19/411,348

(22) Filed: Dec. 7, 2025

Related U.S. Application Data
(63) Continuation-in-part of application No. 18/677,908, filed on May 30, 2024, now abandoned.

(30) Foreign Application Priority Data
Oct. 27, 2025 (TW) 114141332

(51) Int. Cl. G06F 3/041

(52) U.S. Cl. CPC G06F 3/0416

(57) ABSTRACT

A touch controller including an analog front-end circuit, an analog-to-digital converter circuit, a first demodulator circuit, a second demodulator circuit, and a processor circuit. The analog front-end circuit receives a touch sensing signal from a touch display panel. The touch sensing signal includes a first coded signal corresponding to a first user. The analog-to-digital converter circuit converts the touch sensing signal into a digital signal. The first demodulator circuit and the second demodulator circuit respectively demodulate the digital signal to obtain a first touch raw data corresponding to the first user and a second touch raw data corresponding to a second user. The processor circuit generates a first report data and a second report data according to the first touch raw data and the second touch raw data respectively. The processor circuit identifies whether a current touch behavior is that of the first user according to the first coded signal.

### CROSS-REFERENCE TO RELATED APPLICATION

This application is a continuation-in-part application of and claims the priority benefit of a prior application Ser. No. 18/677,908, filed on May 30, 2024. This application claims the priority benefit of Taiwan application serial no. 114141332, filed on October 27, 2025. The entirety of each of the above-mentioned patent applications is hereby incorporated by reference herein and made a part of this specification.

### BACKGROUND

### Technical Field

The disclosure relates to a controller and an identification method, and more particularly to a touch controller and a touch identification method.

### Description of Related Art

In general vehicle touch applications, the touch controller cannot identify individual touch behaviors of the driver and the passenger. Since the driver must pay attention to driving safety, it is necessary to impose special restrictions on the driver’s touch behavior. For example, after the driver presses a menu, only basic function such as making phone calls, air conditioning, etc. may appear as options, while functions that may endanger driving safety, such as audio-video playback, shopping, etc., are prohibited from appearing as options. Alternatively, functions that may endanger driving safety may be irresponsive when the driver touches such functions, thereby prohibiting the driver from using such functions so as to ensure driving safety.

### SUMMARY

The disclosure provides a touch controller and a touch identification method, which may be used to identify whether a current touch behavior is a touch behavior of a specific user.

A touch controller of an embodiment of the disclosure includes an analog front-end circuit, an analog-to-digital converter circuit, a first demodulator circuit, a second demodulator circuit, and a processor circuit. The analog front-end circuit receives a touch sensing signal from a touch display panel. The touch sensing signal includes a first coded signal corresponding to a first user. The analog-to-digital converter circuit converts the touch sensing signal to a digital signal. The first demodulator circuit and the second demodulator circuit respectively demodulate the digital signal to obtain a first touch raw data corresponding to the first user and a second touch raw data corresponding to a second user. The processor circuit generates a first report data and a second report data according to the first touch raw data and the second touch raw data respectively. The processor circuit identifies whether a current touch behavior is a touch behavior of the first user according to a first coded signal.

A touch identification method of an embodiment of the disclosure includes the following steps. A touch sensing signal is received from a touch display panel, and the touch sensing signal is converted to a digital signal. The touch sensing signal includes a first coded signal corresponding to a first user. The digital signal is demodulated to obtain a first touch raw data corresponding to the first user and a second touch raw data corresponding to a second user. A first report data and a second report data are generated according to the first touch raw data and the second touch raw data respectively. Whether a current touch behavior is a touch behavior of the first user is identified according to the first coded signal.

To make the above features and advantages of the disclosure more apparent and understandable, embodiments are specifically provided below and described in detail with reference to the accompanying drawings as follows.

### BRIEF DESCRIPTION OF THE DRAWINGS

FIG. 1 illustrates a schematic diagram of an application scenario of vehicle user touch identification according to an embodiment of the disclosure.

FIG. 2A illustrates a timing diagram of time-division driving for display driving and touch sensing according to an embodiment of the disclosure.

FIG. 2B illustrates a driving timing diagram of a touch display panel according to an embodiment of the disclosure.

FIG. 2C illustrates a driving timing diagram of a touch display panel according to another embodiment of the disclosure.

FIG. 3 illustrates a timing diagram of time-division driving for display driving and touch sensing according to another embodiment of the disclosure.

FIG. 4 illustrates a schematic diagram of internal circuits of the touch controller of the embodiment of FIG. 1.

FIG. 5 illustrates a schematic diagram of a graphical user interface displaying touch positions according to an embodiment of the disclosure.

FIG. 6 illustrates a schematic diagram of internal circuits of a touch controller according to another embodiment of the disclosure.

FIG. 7 illustrates a schematic diagram of an application scenario of vehicle user touch identification according to another embodiment of the disclosure.

FIG. 8 illustrates a schematic diagram of internal circuits of the touch controller of the embodiment of FIG. 7.

FIG. 9A, FIG. 9B, FIG. 9C, and FIG. 9D illustrate schematic diagrams of semiconductor chips for providing reference signals and coded signals according to embodiments of the disclosure.

FIG. 10 illustrates a distribution diagram of touch sensors on a touch display panel according to an embodiment of the disclosure.

FIG. 11 illustrates a distribution diagram of touch sensors on a touch display panel according to another embodiment of the disclosure.

FIG. 12 illustrates a flowchart of steps of a touch identification method according to an embodiment of the disclosure.

### DESCRIPTION OF THE EMBODIMENTS

The term “couple (or connect)” used throughout the specification (including the claims) may refer to any direct or indirect connection methods. For example, if the text describes that a first device is coupled (or connected) to a second device, it should be interpreted that the first device may be directly connected to the second device, or the first device may be indirectly connected to the second device through other devices or some connection methods. The terms “first,” “second,” etc. mentioned throughout the specification (including the claims) are used to name elements or to distinguish different embodiments or scopes, and are not used to limit the upper or lower limits of the number of elements, nor to limit the order of elements. In addition, wherever possible, elements/components/steps using the same reference numerals in the drawings and embodiments represent the same or similar parts. Elements/components/steps using the same reference numerals or the same terms in different embodiments may cross-reference related descriptions.

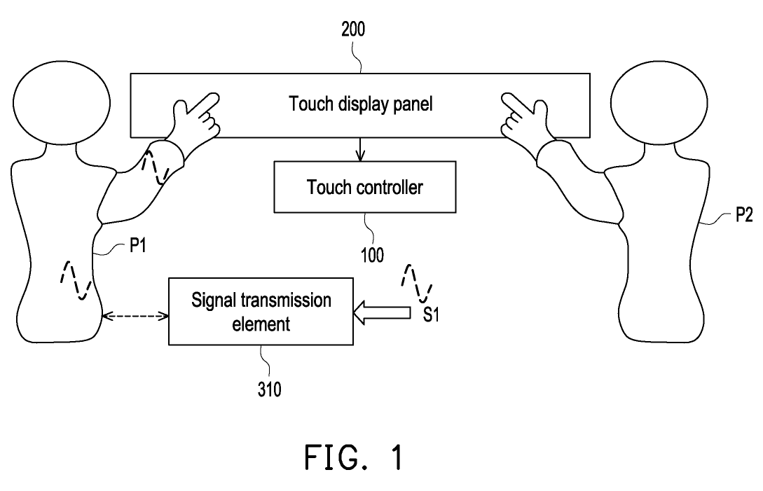

FIG. 1 illustrates a schematic diagram of an application scenario of vehicle user touch identification according to an embodiment of the disclosure. Referring to FIG. 1, in vehicle touch applications, a touch controller 100 may identify touch behaviors of a driver P1 and a passenger P2. For driving safety, it is necessary to restrict scenarios where the driver uses a touch display panel 200, especially when the vehicle is in motion.

For example, when the vehicle is in motion, after a menu on the touch display panel 200 is selected, if the touch controller 100 determines that it is a touch behavior of the driver P1 (first user), the menu on the touch display panel 200 may only display basic function options, such as making phone calls and air conditioning, while prohibiting function options that may affect driving safety, such as audio-video playback and shopping. Alternatively, when it is detected that the driver P1 touches function options that may affect driving safety, the corresponding functions become irresponsive to prohibit the driver P1 from using such functions so as to ensure driving safety.

In an embodiment, the display information of the touch display panel 200 is provided by a main controller on the vehicle. When a user touches the touch display panel 200, which generates a touch event, the touch controller 100 detects and determines the position of the touch event and transmits the position information to the main controller. The main controller determines the user’s operation according to the position information, and causes the touch display panel 200 to display information corresponding to the user’s operation. To improve the safety of vehicle driving and avoid risks caused by the driver operating the touch display panel 200, when the touch controller 100 transmits position information of each touch event to the main controller, information of the toucher is added to the position information.

For example, the original position information may include just the X-axis coordinate and Y-axis coordinate of the touch event on the touch display panel 200, but the position information in the embodiment of the disclosure adds operator information such as P1 and P2. In this way, when the main controller receives the position information of the touch event, the main controller may first decide whether to execute the user’s operation according to the operator information. In another embodiment, the main controller also receives other information of the vehicle, such as vehicle speed. When the main controller receives the touch event position information, if the vehicle speed is lower than a speed at this time, such as 20 kilometers per hour, the main controller may allow the driver to perform more operations.

Furthermore, the main controller may provide the driver with different permission operations on the touch display panel 200 under different circumstances. When the vehicle is not started, or when the vehicle is started but the vehicle speed is zero or lower than a first predetermined speed such as 10 kilometers per hour, the driver may obtain complete operation permission of the touch display panel 200. When the vehicle speed is greater than a second predetermined speed such as 20 kilometers per hour, the driver obtains minimum operation permission and may only perform basic operations, such as making phone calls, adjusting air conditioning temperature, and volume adjustment. When the vehicle speed is between the first predetermined speed and the second predetermined speed, the driver may obtain more operation permissions, such as reading calendar information.

In another embodiment, only when the vehicle is in a stationary state may the driver obtain complete operation permission of the touch display panel 200. Once the main controller of the vehicle detects that the vehicle starts to move, the driver may only obtain partial operation permission of the touch display panel 200. In an embodiment, when the vehicle starts to move, the main controller of the vehicle transmits an operation restriction signal to the touch controller 100 of the touch display panel 200. When the touch controller 100 detects that the position touched by the driver is located in a restricted area, such as an icon for audio-visual operation or a keyboard, the touch controller 100 does not transmit the touch position information to the main controller of the vehicle. In another embodiment, the position information transmitted by the touch controller 100 to the main controller of the vehicle includes personnel information, such as the driver being P1 and the passenger being P2. When the main controller of the vehicle determines that the driver’s attempt to operate a function that poses a safety risk while the vehicle is moving is received, the main controller does not respond to the driver’s operation, or displays a safety warning signal on the touch display panel 200 or emits a safety warning prompt sound to inform the driver that the current operation is risky.

In order to achieve the above purpose, the touch controller 100 is equipped with a vehicle user touch identification function. A coded signal S1 is transmitted to the driver P1 through a signal transmission element 310. When the driver P1 performs a touch operation on the touch display panel 200, the touch controller 100 may perform signal processing on the sensed coded signal S1 (first coded signal) to identify whether the touch behavior comes from the driver P1. Therefore, through this method, the touch controller 100 may identify the touch behaviors of two or more users.

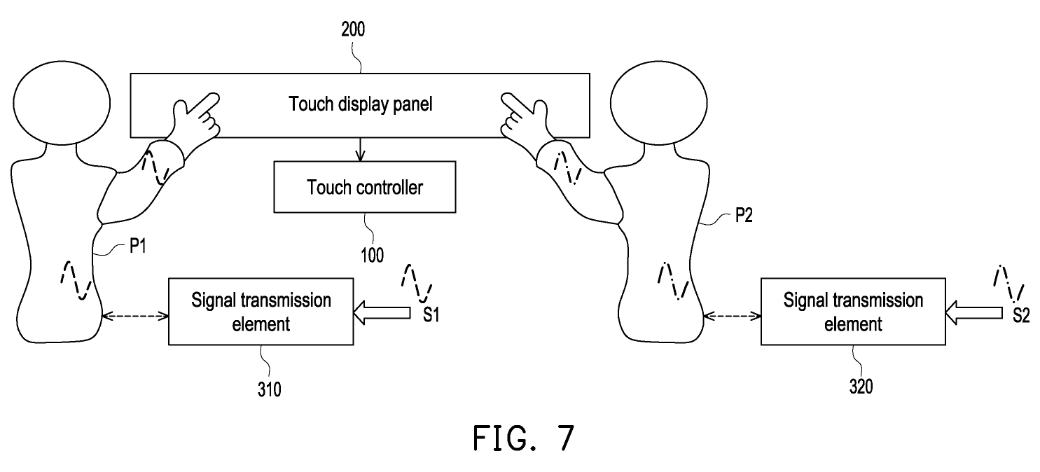

The coded signal S1 is, for example, a continuous sine wave, square wave, or other coded signal, which may be provided by the touch controller 100, a function generator, an arbitrary waveform generator, or a vehicle system, and the disclosure is not limited thereto. In this embodiment, the passenger P2 (the second user) may be coupled to the ground or be in a floating state, and the disclosure is not limited thereto. In another embodiment (FIG. 7), the passenger P2 may be coupled to another coded signal S2. In another embodiment, only the driver P1 has a similar mechanism, the passenger P2 does not receive a signal similar to the coded signal S1, and nothing similar to the signal transmission element 310 is provided to the passenger P2.

The signal transmission element 310 is, for example, an electrode sheet or conductive sheet, which may be included in vehicle elements such as a steering wheel, seat, cushion, pedal, or floor mat. The signal transmission element 310 may be in direct contact, indirect contact, or signal connection with the driver P1. When the driver P1 operates on the touch display panel 200, the body receives a specific signal through the coupled signal transmission element 310. Therefore, when operating the touch display panel 200, the specific signal is transmitted to the touch display panel 200 through the finger of the driver P1. In an embodiment, both the driver P1 and the passenger P2 may receive specific signals through devices such as the signal transmission element 310, allowing the touch display panel 200 to know who is currently operating.

In an embodiment, the touch controller 100 is, for example, a touch control chip or a Touch with Display Driver IC (TDDI). In addition, referring to the common knowledge in the art, sufficient teaching, suggestions, and implementation descriptions of the hardware structures of the touch controller 100 and the touch display panel 200 may be obtained.

In the embodiment of the disclosure, due to the addition of a specific identification signal such as the coded signal S1, the touch controller 100 needs to first perform demodulation or decoding when detecting a touch so as to determine who is performing the operation.

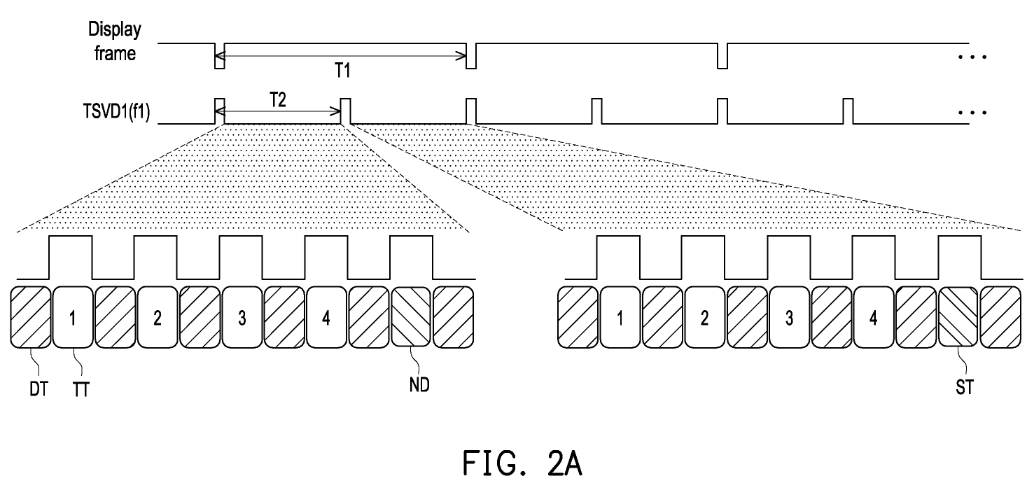

FIG. 2A illustrates a timing diagram of display driving and touch sensing time-division driving according to an embodiment of the disclosure. Referring to FIG. 2A, TSVD1 is a touch synchronous vertical signal, and its frame term T2 is smaller than a display frame term T1. In this example, the time length of the display frame term T1 is twice that of the touch sensing frame term T2, but the disclosure is not limited thereto. In the touch synchronous vertical signal TSVD1, every two frame terms T2 include a display term DT, a touch sensing term TT, a noise detection term ND, and a self-testing term ST.

In the display term DT, the touch display panel 200 is driven to display images. In the touch sensing term TT, the touch controller 100 may simultaneously process two or more coded signals, and correspondingly generate demodulated decoded signals and touch report information to identify and present touch behaviors of multiple users. More specifically, when the touch controller 100 detects a touch event, the touch controller 100 will first determine who triggered the touch event.

FIG. 2B illustrates a driving timing diagram of a touch display panel according to an embodiment of the disclosure. Referring to FIG. 2B, one frame term of the touch display panel 200 includes a display term DP, a touch sensing term TD, and an object identification term UID. That is, one frame term of the touch display panel 200 originally includes the display term DP and the touch sensing term TD. In response to the sensing method that may determine different users, one frame term of the touch display panel 200 further includes the object identification term UID.

The touch controller 100 identifies and presents touch behaviors of multiple users according to the demodulated decoded signals and touch report information, which may be performed in the object identification term UID of FIG. 2B.

FIG. 2C illustrates a driving timing diagram of a touch display panel according to another embodiment of the disclosure. Referring to FIG. 2C, the object identification term UID may also be before the touch sensing term TD. That is, the touch controller 100 first performs object identification, and then performs touch position analysis. When the touch controller 100 transmits touch position data, there is one additional bit to indicate whether it is a driver’s operation.

Therefore, when the vehicle is moving or moves at a speed greater than a predetermined speed, if the touch controller 100 detects a touch event, the touch controller 100 first determines whether it is a driver’s operation during the object identification term UID. If so, the touch controller 100 does not perform touch position analysis.

Conversely, if it is not a driver’s operation, but the touch controller 100 senses a signal from the passenger seat and determines it to be a passenger’s operation during the object identification term UID, the touch controller 100 further performs passenger touch position analysis. Therefore, the signal from the passenger seat will only exist when the passenger is in the seat. If the touch controller 100 determines that there is no signal from the passenger seat when the vehicle is moving, it indicates that it is not a passenger operation, therefore the touch controller 100 does not respond. The touch controller 100 only ignores this touch event when the touch controller 100 fails to decode the correct signal after decoding or demodulating. Therefore, only when the touch controller 100 decodes or demodulates and obtains a signal from the passenger seat, further determining a passenger, will it perform report.

In the noise detection term ND, the touch controller 100 detects noise of multiple signal frequencies to determine the signal frequency points of the noise, thereby determining that the frequency of touch sensing operates at the minimum signal frequency point of the noise.

In the self-testing term ST, the touch controller 100 may detect in real time whether the touch sensor on the touch display panel 200 has short circuit or open circuit problems to ensure the safety of vehicle applications.

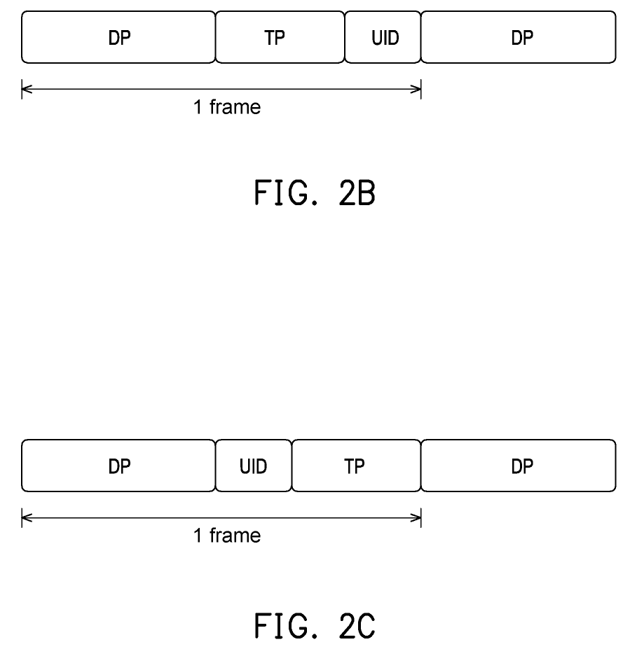

FIG. 3 illustrates a timing diagram of time-division driving for display driving and touch sensing according to another embodiment of the disclosure. Referring to FIG. 3, TSVD2 is a touch synchronous vertical signal, and its frequency f2 is smaller than a frequency f1 of the touch synchronous vertical signal TSVD1. In this example, the frequency f1 of the touch synchronous vertical signal TSVD1 is twice the frequency f2 of the touch synchronous vertical signal TSVD2, but the disclosure is not limited thereto. In addition, the display frame term T1 and a touch sensing frame term T3 have equal time lengths.

In this embodiment, the touch controller 100 performs touch sensing operation during a time interval T4 between every two frame terms T3. Each time interval T4 includes a display term DT, a touch sensing term TT, a noise detection term ND, and a self-testing term ST. During the touch sensing term TT, the touch controller 100 may simultaneously process two or more coded signals, and correspondingly generate demodulated decoded signals and touch report information.

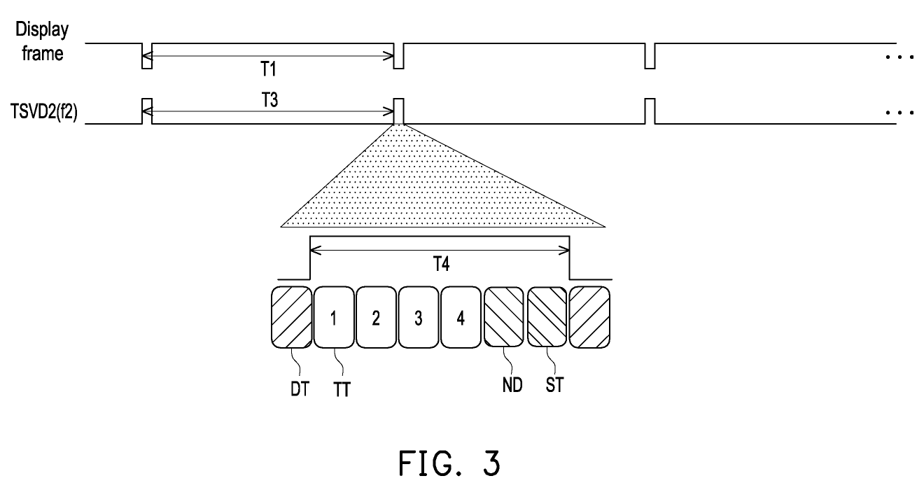

FIG. 4 illustrates a schematic diagram of the internal circuit of the touch controller of the embodiment of FIG. 1. Referring to FIG. 4, the touch controller 100 includes an analog front-end (AFE) circuit 110, an analog-to-digital converter (ADC) circuit 120, a first demodulator circuit 130_1, a second demodulator circuit 130_2, and a processor circuit 140.

The inverting input end of the AFE circuit 110 receives a touch sensing signal S3 from the driver P1 or the passenger P2 through the touch display panel 200. The AFE circuit 110 serves as the input end of the touch controller 100 for receiving and processing analog signals from the touch display panel 200, and adjusts the signals to specifications suitable for input to the ADC circuit 120 through amplification, filtering, adjustment, and other methods. In this embodiment, the non-inverting input end of the AFE circuit 110 is coupled to a reference signal VTX. The reference signal VTX may serve as a reference for the processor circuit 140 to generate report data. The reference signal VTX may be provided by a signal generation circuit (not shown) inside the touch controller 100. In another embodiment, the non-inverting input end of the AFE circuit 110 may also not be coupled to the reference signal VTX and may be in a floating state.

Taking the application scenario of FIG. 1 as an example, the driver P1 is coupled to the coded signal S1, for example, while the passenger P2 is in a floating state. During the touch sensing term TT, the AFE circuit 110 may apply the reference signal VTX as a drive signal to the touch sensor (such as a touch electrode) on the touch display panel 200 through the virtual short circuit characteristic of the operational amplifier. Then, the AFE circuit 110 receives the touch sensing signal S3. The touch sensing signal S3 includes the coded information of the coded signal S1 coupled to the driver P1.

In another embodiment, the touch sensing signal S3 may include frequency information of the signal coupled to the driver P1. The touch controller 100 may demodulate signals of specific frequencies.

Next, the ADC circuit 120 receives the touch sensing signal S3 from the AFE circuit 110, and converts the touch sensing signal S3 to a digital signal S4. The first demodulator circuit 130_1 is configured to demodulate the digital signal S4 to obtain a decoded touch raw data TRD1 (first touch raw data) related to the driver P1. On the other hand, the second demodulator circuit 130_2 is configured to demodulate the digital signal S4 to obtain a decoded touch raw data TRD2 (second touch raw data) related to the passenger P2.

Subsequently, the processor circuit 140 receives the touch raw data TRD1 and TRD2, and accordingly generates a first report data D1 corresponding to the driver P1 and a second report data D2 corresponding to the passenger P2. The touch raw data TRD1 may also include driver information, which is not limited by the disclosure.

In addition, the touch raw data TRD1 and TRD2 may include a bit that is configured to record who touches. For example, a bit value of 1 indicates driver touch, and a bit value of 0 indicates passenger touch. The vehicle controller may determine during driving that if a specific bit is 1, no corresponding action will be taken for that report data.

In this embodiment, since the passenger P2 is in a floating state, the generation method of the second report data D2 is mainly based on driving the touch sensor with the reference signal VTX to generate the touch sensing signal S3. On the other hand, since the driver P1 is coupled to the coded signal S1, the processor circuit 140 may further identify whether the current touch behavior is the touch behavior of the driver P1 according to the coded signal S1.

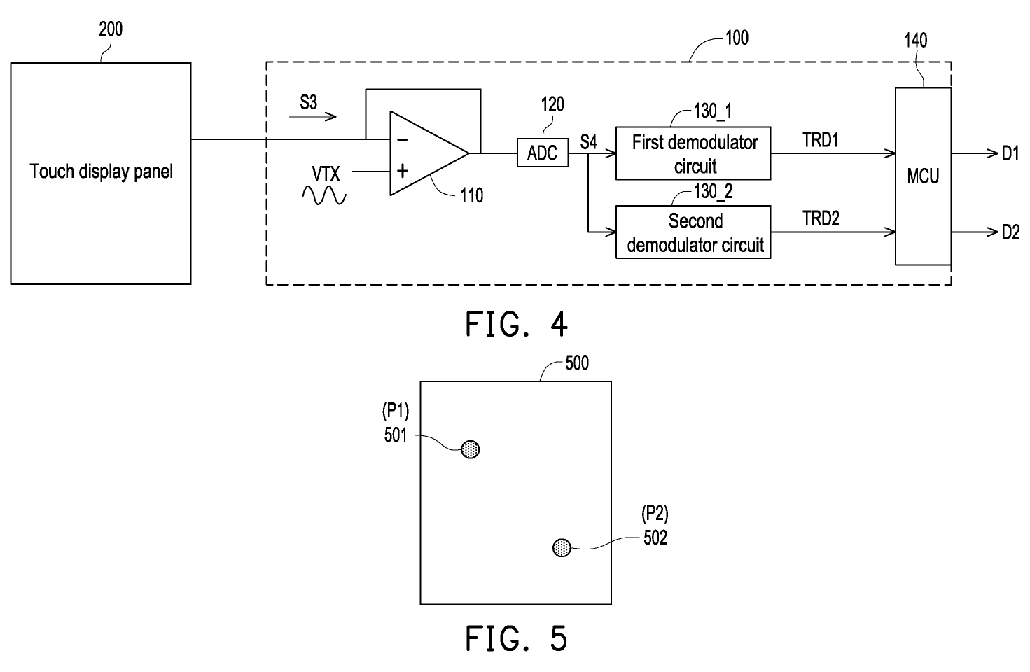

Therefore, in the embodiments of FIG. 1 and FIG. 4, the touch controller 100 may simultaneously process touch sensing signals S3 related to multiple users during the same touch sensing term TT, and may demodulate corresponding decoded signals TRD1 and TRD2. Then, after being processed by the processor circuit 140, the report data D1 and D2 are output to the backend system. Therefore, the backend system may simultaneously display touch positions 501 and 502 of multiple users on a graphical user interface (GUI) 500, as shown in FIG. 5. The graphical user interface 500 is, for example, displayed on the touch display panel 200.

In this embodiment, the report data format may be defined to include coordinate point data and identification indicators. Taking two users as an example, the identification indicator of the driver P1 is 0x01, and the identification indicator of the passenger P2 is 0x02. Therefore, the report data D1 of the driver P1 may be a combination of the coordinate point data of the touch position 501 and the identification indicator of 0x01, and the report data D2 of the passenger P2 may be a combination of the coordinate point data of the touch position 502 and the identification indicator of 0x02. However, the disclosure does not limit the definition of the report data format. In application embodiments with multiple users, the identification indicator of another passenger may be further defined as 0x03, and so on.

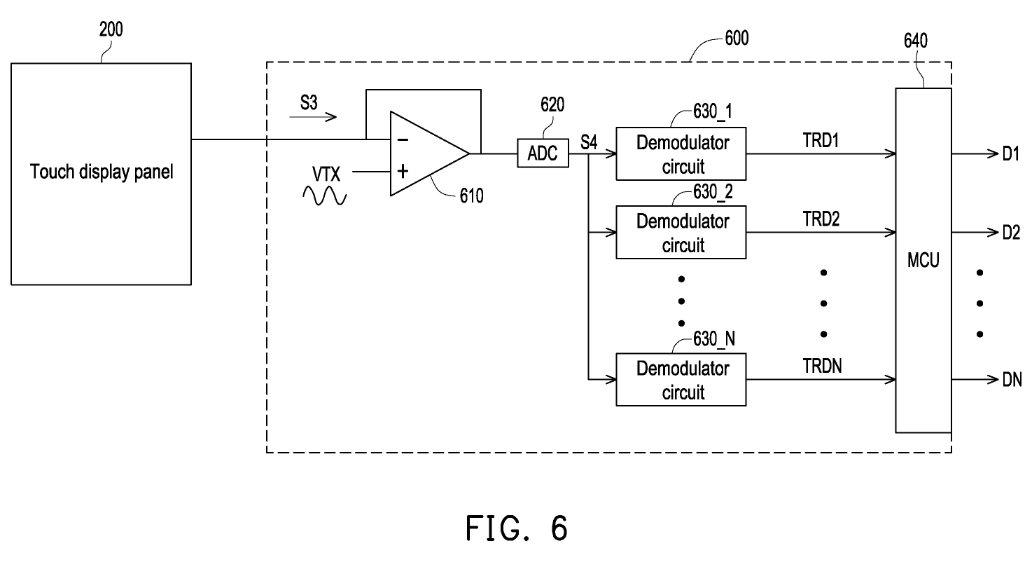

FIG. 6 illustrates a schematic diagram of internal circuits of a touch controller according to another embodiment of the disclosure. Referring to FIG. 6, in this embodiment, an AFE circuit 610 may receive two or more types of coded signals, which undergo electrical conversion (for example, capacitance to current and then current to voltage) and are then provided to the backend digital circuits. Moreover, a touch controller 600 is equipped with multiple demodulator circuits 630_1~630_N, respectively demodulating voltage signals of multiple different components to generate corresponding decoded signals (i.e., touch raw data), which are then provided to a processor circuit 640 for processing. Therefore, the touch controller 600 may identify three or more user touch behaviors, where N is a positive integer greater than 2.

In an embodiment, the processor circuits 140 and 640 are, for example, a central processing unit (CPU), or other programmable general-purpose or special-purpose micro control unit (MCU), microprocessor, digital signal processor (DSP), programmable controller, application specific integrated circuit (ASIC), graphics processing unit (GPU), image signal processor (ISP), image processing unit (IPU), arithmetic logic unit (ALU), complex programmable logic device (CPLD), field programmable gate array (FPGA) or other similar elements or combinations of the above elements.

In addition, referring to the common knowledge in the art, sufficient teaching, suggestions and implementation descriptions of the hardware structures of ADC circuits 120 and 620, and the demodulator circuits 130_1, 130_2, and 630_1~630_N may be obtained.

In an embodiment, the touch display panel 200 may be a self-luminous display panel, such as an organic light-emitting diode (OLED) display panel, or a flat or curved thin display device of types such as liquid-crystal display (LCD). In other embodiments, the touch display panel 200 may also be a touch display panel including micro LED or mini LED. The disclosure does not limit the types of touch display panels.

FIG. 7 illustrates a schematic diagram of an application scenario of vehicle user touch identification according to another embodiment of the disclosure, wherein the passenger P2 is coupled to another coded signal S2. The frequency of the coded signal S2 is different from the frequency of the coded signal S1. The processor circuit may identify whether the current touch behavior is the touch behavior of the passenger P2 according to the coded signal S2.

The coded signal S2 is transmitted to the passenger P2 through a signal transmission element 320. The signal transmission element 320 is, for example, an electrode sheet or conductive sheet, which may be included in vehicle elements such as steering wheel, seat, cushion, pedal or floor mat. The signal transmission element 320 may be in direct contact, indirect contact or signal connection with the passenger P2.

When the driver P1 and the passenger P2 perform touch operations on the touch display panel 200, the touch controller 100 may perform signal processing on the sensed coded signals S1 and S2 to identify whether the touch behavior is from the driver P1 or the passenger P2.

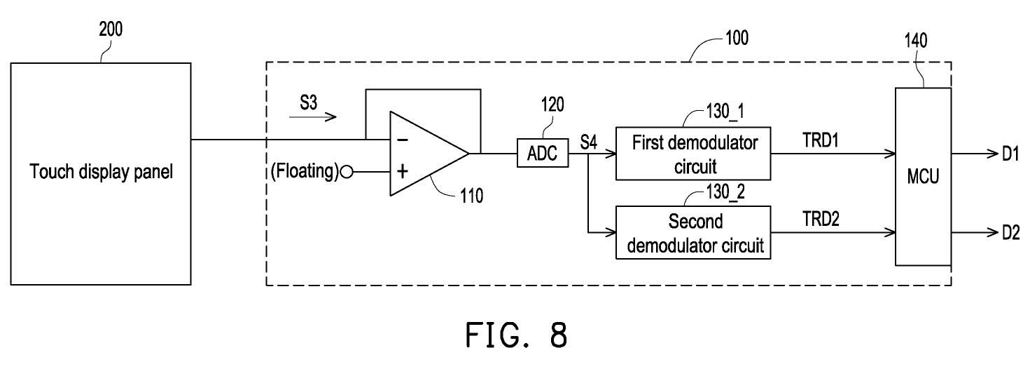

FIG. 8 illustrates a schematic diagram of the internal circuit of the touch controller of the embodiment of FIG. 7, wherein the internal circuit structure of the touch controller 100 is the same as FIG. 4, except that the non-inverting input end of the AFE circuit 110 is in a floating state and is not coupled to the reference signal VTX. In this example, during the touch sensing term TT, the AFE circuit 110 does not apply the reference signal VTX to the touch sensor on the touch display panel 200, but directly receives the touch sensing signal S3 when the driver P1 and the passenger P2 perform touch behaviors. Then, the first demodulator circuit 130_1 and the second demodulator circuit 130_2 respectively demodulate the digital signal S4 to obtain the touch raw data TRD1 and TRD2. The touch sensing signal S3 and the digital signal S4 include the coded information of the coded signals S1 and S2.

In this embodiment, since the driver P1 is coupled to the coded signal S1 and the passenger P2 is coupled to the coded signal S2, the processor circuit 140 may determine which user’s touch behavior it is and the touch position thereof according to the coded signals S1 and S2.

In vehicle application scenarios, the touch display areas of the cabin may include an instrument cluster and a center information display (CID). These two touch display areas may be implemented by the same touch display panel or different touch display panels. Therefore, the electronic circuits configured to drive and control the cabin display areas may also include a single semiconductor chip or multiple different semiconductor chips. The semiconductor chip may be a touch controller chip or a touch display driver integrated chip to implement the touch identification method of the aforementioned embodiments.

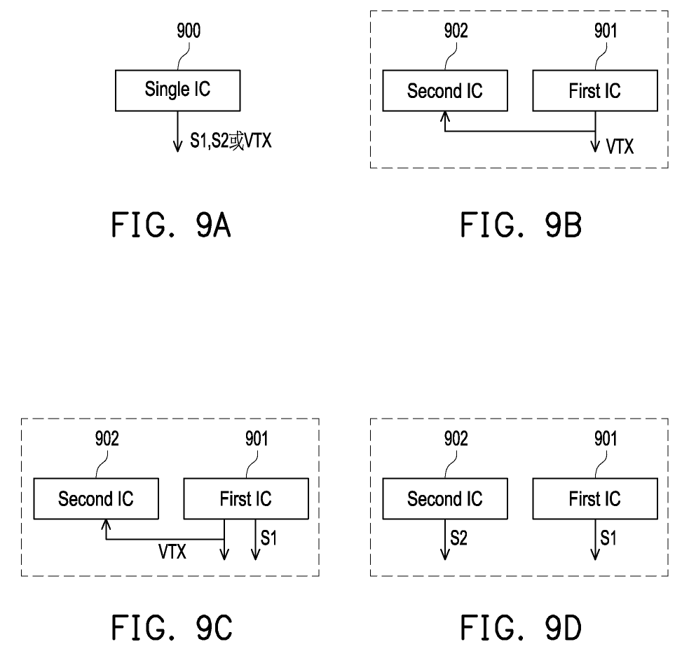

In the embodiment of a single semiconductor chip, a semiconductor chip 900 may be configured to provide the reference signal VTX or the coded signals S1 and S2, as shown in FIG. 9A. In the embodiment of multiple semiconductor chips, a first semiconductor chip 901 and a second semiconductor chip 902 may be configured to provide the reference signal VTX or the coded signals S1 and S2, as shown in FIG. 9B, FIG. 9C and FIG. 9D. Alternatively, in other embodiments, the reference signal VTX and the coded signals S1 and S2 may also be provided by an external function wave generator or arbitrary waveform generator. The chip configurations and signal providing methods shown in FIG. 9A to FIG. 9D are only used for illustrative purposes and are not intended to limit the disclosure.

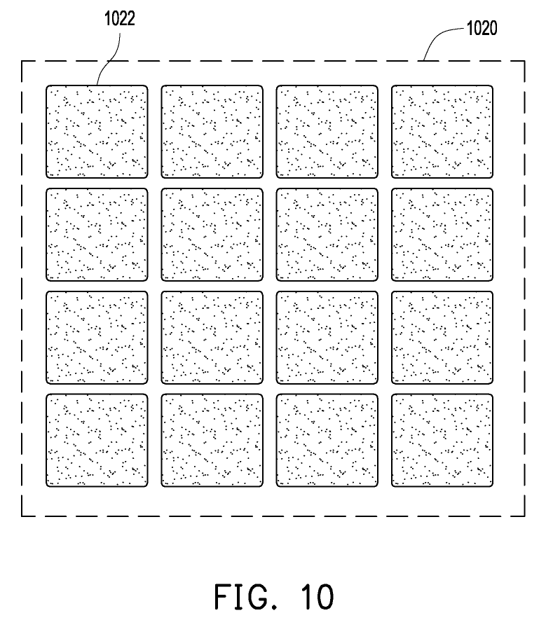

FIG. 10 illustrates a distribution diagram of touch sensors on a touch display panel according to an embodiment of the disclosure. Referring to FIG. 10, in this embodiment, a touch display panel 1020 is a self-capacitive touch panel, including a plurality of block electrodes 1022 arranged in an array manner as touch sensors. The touch controller 100 may drive the touch display panel 1020 to perform touch sensing operations through self-capacitive sensing technology to detect, demodulate, and decode the report data of the driver P1 or the passenger P2.

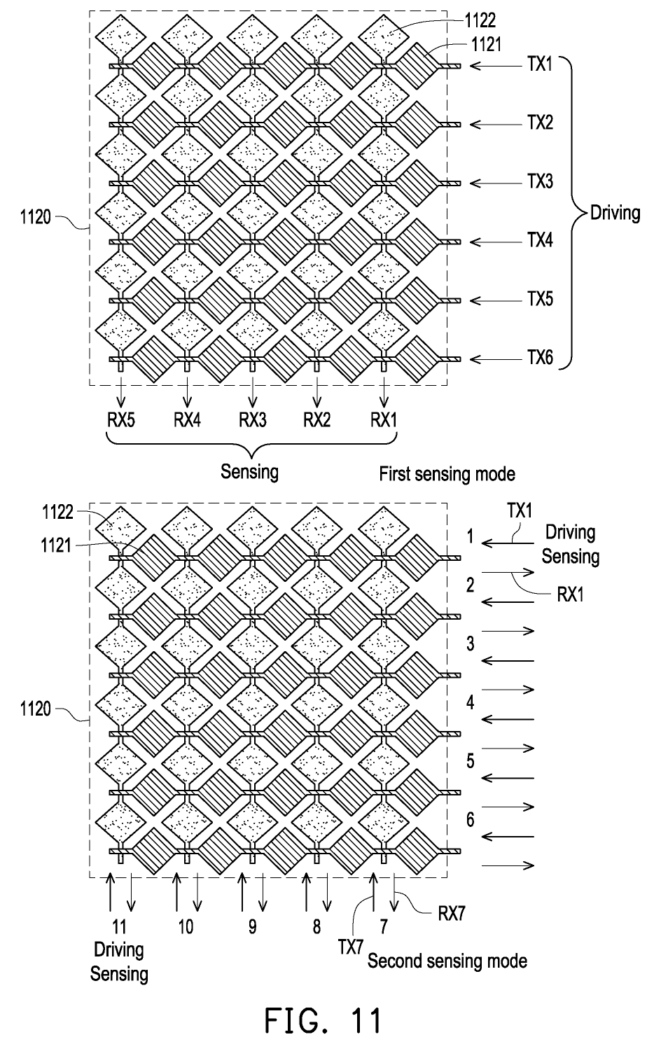

FIG. 11 illustrates a distribution diagram of touch sensors on a touch display panel according to another embodiment of the disclosure. Referring to FIG. 11, in this embodiment, a touch display panel 1120 includes a plurality of driving electrodes 1121 and a plurality of sensing electrodes 1122. According to different driving methods, the touch display panel 1120 may operate in a first sensing mode or a second sensing mode. In the first sensing mode, the touch controller 100 applies drive signals TX1~TX6 to the driving electrodes 1121 and receives sensing signals RX1~RX5 from the sensing electrodes 1122.

In the second sensing mode, taking the driving electrode 1121 as an example, the touch controller 100 may apply a drive signal TX1 to the driving electrode 1121 and receive a sensing signal RX1 from the driving electrode 1121. In this example, the driving electrode 1121 also serves as a sensing electrode. Taking the sensing electrode 1122 as another example, the touch controller 100 may apply a drive signal TX7 to the sensing electrode 1122 and receive a sensing signal RX7 from the sensing electrode 1122. In this example, the sensing electrode 1122 also serves as a driving electrode.

Therefore, in this embodiment, the touch controller 100 may drive the touch display panel 1120 to perform touch sensing operations through the first sensing mode or the second sensing mode to detect, demodulate, and decode the report data of the driver P1 or the passenger P2.

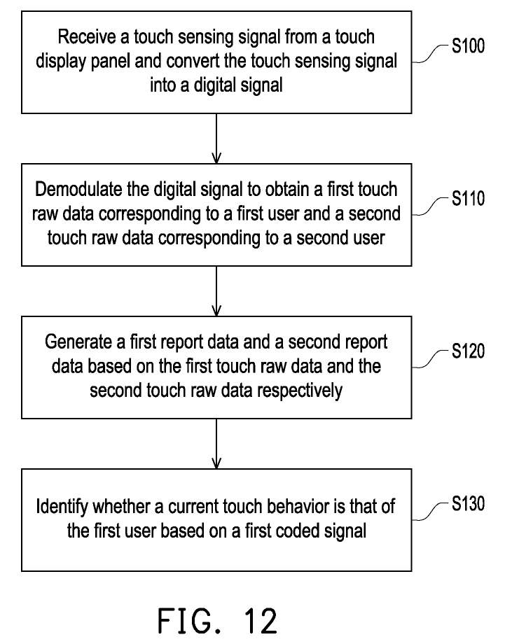

FIG. 12 illustrates a flowchart of steps of a touch identification method according to an embodiment of the disclosure. Referring to FIG. 4 and FIG. 12, the touch identification method of this embodiment is at least applicable to the touch controller 100 of FIG. 4, but the disclosure is not limited thereto.

In step S100, the AFE circuit 110 receives the touch sensing signal S3 from the touch display panel 200, and the ADC circuit 120 converts the touch sensing signal S3 to a digital signal S4. In step S110, the first demodulator circuit 130_1 and the second demodulator circuit 130_2 respectively demodulate the digital signal S4 to obtain the touch raw data TRD1 corresponding to the first user (the driver P1) and the touch raw data TRD2 corresponding to the second user (the passenger P2). In step S120, the processor circuit 140 generates first report data D1 and second report data D2 respectively according to the touch raw data TRD1 and TRD2. In step S130, the processor circuit 140 identifies whether the current touch behavior is the touch behavior of the first user (the driver P1) according to the coded signal S1.

In addition, the touch identification method of this embodiment may obtain sufficient teaching, suggestions and implementation instructions from the descriptions of the embodiments of FIG. 1 to FIG. 11, and therefore will not be described in detail.

In summary, in the embodiments of the disclosure, the touch controller may identify whether the current touch behavior is the touch behavior of the driver according to the coded signal through the touch identification method. After identifying the touch behavior of the driver, the touch controller may decide whether to impose restrictions on the touch behavior of the driver to ensure driving safety.

Although the disclosure has been disclosed above with embodiments, they are not intended to limit the disclosure. Any person having ordinary knowledge in the technical field may make slight modifications and refinements without departing from the spirit and scope of the disclosure. Therefore, the protection scope of the disclosure shall be defined by the appended claims.

What is claimed is:

1. A touch controller, comprising:
an analog front-end circuit, receiving a touch sensing signal from a touch display panel, wherein the touch sensing signal comprises a first coded signal corresponding to a first user;
an analog-to-digital converter circuit, converting the touch sensing signal to a digital signal;
a first demodulator circuit and a second demodulator circuit, respectively demodulating the digital signal to obtain a first touch raw data corresponding to the first user and a second touch raw data corresponding to a second user; and
a processor circuit, generating a first report data and a second report data according to the first touch raw data and the second touch raw data respectively,
wherein the processor circuit identifies whether a current touch behavior is a touch behavior of the first user according to the first coded signal.

2. The touch controller of claim 1, wherein the analog front-end circuit comprises an inverting input end and a non-inverting input end, and the inverting input end of the analog front-end circuit is configured to receive the touch sensing signal from the touch display panel.

3. The touch controller of claim 2, wherein the non-inverting input end of the analog front-end circuit is coupled to a reference signal.

4. The touch controller of claim 3, wherein the reference signal is applied to the touch display panel during a touch sensing term to drive the touch display panel to perform a touch sensing operation.

5. The touch controller of claim 2, wherein the non-inverting input end of the analog front-end circuit is in a floating state.

6. The touch controller of claim 2, wherein the non-inverting input end of the analog front-end circuit is coupled to a ground.

7. The touch controller of claim 1, wherein the first coded signal is transmitted to the first user through a first signal transmission element.

8. The touch controller of claim 1, wherein the touch sensing signal comprises a second coded signal corresponding to the second user, and the processor circuit identifies whether a current touch behavior is a touch behavior of the second user according to the second coded signal.

9. The touch controller of claim 8, wherein the second coded signal is transmitted to the second user through a second signal transmission element.

10. A touch identification method, comprising:
receiving a touch sensing signal from a touch display panel, and converting the touch sensing signal to a digital signal, wherein the touch sensing signal comprises a first coded signal corresponding to a first user;
demodulating the digital signal to obtain a first touch raw data corresponding to the first user and a second touch raw data corresponding to a second user;
generating a first report data and a second report data according to the first touch raw data and the second touch raw data respectively; and
identifying whether a current touch behavior is a touch behavior of the first user according to the first coded signal.

11. The touch identification method of claim 10, further comprising:
applying a reference signal to the touch display panel through an analog front-end circuit during a touch sensing term to drive the touch display panel to perform a touch sensing operation.

12. The touch identification method of claim 10, further comprising:
transmitting the first coded signal to the first user through a first signal transmission element.

13. The touch identification method of claim 10, wherein the touch sensing signal comprises a second coded signal corresponding to the second user, and the touch identification method further comprises:
identifying whether a current touch behavior is a touch behavior of the second user according to the second coded signal.

14. The touch identification method of claim 13, further comprising:
transmitting the second coded signal to the second user through a second signal transmission element.
